(19) United States
(12) Patent Application Publication
(10) Pub. No.: US 2006/0267790 A1
(43) Pub. Date: Nov. 30, 2006

(54) Modular system for electronic assembly units worn close to the body

(75) Inventors: Hans Matthiessen, Bad Schwartau (DE); Robert Sliepen, Aachen (DE); Henning Gerder, Lubeck (DE); Frank Sattler, Lubeck (DE)

Correspondence Address: MCGLEW & TUTTLE, PC, P.O. BOX 9227, SCARBOROUGH STATION, SCARBOROUGH, NY, 10510-9227, US

(73) Assignee: Dräger Safety AG & Co. KGaA, Lubeck (DE)

(21) Appl. No.: 11/372,177

(22) Filed: Mar. 9, 2006

(30) Foreign Application Priority Data
May 24, 2005 (DE) 10 2005 024 447.5

(51) Int. Cl. G08C 19/16

(52) U.S. Cl. 340/870.01

(57) ABSTRACT

A modular system of electronic assembly units worn close to the body can be connected to a central supply module. At least one textile-supported supply line (1) leads to inductive interfaces, with which additional supply lines or electronic assembly units can be coupled, which likewise have at least one inductive interface. At least one portable supply module (6) has a power supply unit (9) and a control unit (10). The control unit (10) is designed such that it can assume a master function in respect to other coupled electronic assembly units, wherein the portable supply module (6) can be coupled via at least one inductive interface with the textile-supported supply line (1) such that it makes possible the power supply of the electronic assembly units (4) by the electronic supply unit (9) contained in the portable supply module (6).

### CROSS REFERENCE TO RELATED APPLICATIONS

This application claims the benefit of priority under 35 U.S.C. §119 of German Patent Application DE 10 2005 024 447.5 filed May 24, 2005, the entire contents of which are incorporated herein by reference.

### FIELD OF THE INVENTION

The present invention pertains to a modular system of electronic assembly units worn close to the body, which can be connected to a central supply module.

### BACKGROUND OF THE INVENTION

It may be necessary or desirable in certain cases to carry various electronic devices or assembly units directly on the body and to operate them simultaneously when needed. Examples can be found in the area of sports and recreational activities as well as professional applications. In particular, mission personnel of technical rescue services such as fire departments, etc., are equipped with numerous electronic devices, whose function is sometimes vitally important, without special attention being able to be paid to their operation in critical situations.

The plurality of electronic devices with which mission personnel are now equipped must all be able to be supplied with power and to communicate with one another electronically.

It is known that electronic components can be integrated in clothing (U.S. Pat. No. 6,729,025 B2), as a result of which the individual components are kept available, in principle, for the wearer of the clothing.

Furthermore, it is known that numerous electronic assembly units worn close to the body can be connected to a central bus system in order to achieve the communication of the individual assembly units (DE 101 20 775 A1). Increased effort arises whenever a plurality of electronic assembly units are to be connected over component limits. This happens, for example, when devices that are integrated in different parts of clothing are to communicate with one another. If the power supply or the data exchange is carried out via wired systems, the mission personnel usually requires especially high-quality and expensive plug type connections, which must meet the requirements of the rough operation. In case of missions in areas with explosion hazard, the use of plug type connections for power supply is, moreover, usually undesirable as a consequence of the fact that sparking hazard can never be ruled out entirely. Communication via RF interfaces in connection with a separate decentralized power supply of every individual assembly unit, for example, in the form of replaceable batteries is considered for use in this case. However, the numerous separate power sources in the form of replaceable batteries or storage batteries mean increased maintenance effort. Numerous moves, which are necessary for the maintenance and the configuration of such a system by connecting plug type contacts, do, moreover, imply an increased risk of error, which may be another disadvantage especially in situations in which little time is available.

### SUMMARY OF THE INVENTION

The object of the present invention is to find a system that makes it possible with little effort to allow a plurality of electronic components worn close to the body to communicate with one another and to supply them with power, can be operated in an environment with explosion hazard and can be manufactured and applied with little effort.

According to the invention, a modular system of electronic assembly units is provided that is worn close to the body. The system can be connected to a central supply module. The system comprises at least one textile-supported supply line, which leads to inductive interfaces, with which additional supply lines or electronic assembly units can be coupled, which likewise have at least one inductive interface. At least one portable supply module is provided with a power supply unit and a control unit, wherein the control unit is designed such that it can assume a master function in respect to additional electronic assembly units. The portable supply module can be coupled via at least one inductive interface with the textile-supported supply line via at least one said inductive interface in such a way that power supply of the electronic assembly units is made possible by the power supply unit contained in the portable supply unit.

Wearing close to the body is defined in the sense of the present invention as the carrying of pieces of equipment in which the pieces of equipment are unambiguously assigned in space to individual users.

The modular system of electronic assembly units worn close to the body are to be connected to the central supply module by the textile-supported supply line. This supply line leads to inductive interfaces, with which additional supply lines or electronic assembly units can be coupled, which likewise have at least one inductive interface.

Due to power supply via inductive interfaces, plug type contacts are dispensable, as a result of which high safety against sparking is achieved, which is an especially great advantage in case of use in an environment with existing explosion hazard. The use of inexpensive inductive interfaces, if they are suitable, which are available in the form of printed circuits, for example, for checking the tire pressure, is advantageous.

It is especially expedient if the portable supply module is additionally equipped with a radio unit, which is designed for connection to additional mobile or stationary units. Members of mission personnel who are equipped with such a modular system can thus communicate with one another.

Furthermore, assembly units or electronic devices, which are to be carried on the body but whose positioning in a particular area of the body is irrelevant, may also be accommodated in the portable supply module. Thus, it may be advantageous if the portable supply module comprises a telemetry unit, which is designed such that it makes possible the bearing of the user of the modular system according to the present invention in hazardous situations. The assembly units accommodated in the portable supply module are advantageously supplied with power via a direct connection with the power supply unit.

It is especially advantageous if the textile-supported supply line is used not only for the power supply of the individual electronic assembly units, but data can additionally also be transmitted between the electronic assembly units and the central supply module via the textile-supported line. This can be embodied, for example, if the portable supply module and at least one other electronic assembly unit can be coupled with the textile-supported supply line via at least one respective inductive interface in such a way that makes possible, on the one hand, a data transmission between the control unit and the additional electronic assembly unit and, on the other hand, the power supply of the electronic assembly unit by the power supply unit contained in the portable supply module. The textile-supported supply line is now part of the bus system according to the present invention. A ring bus design is advantageous.

The design of the bus will not be described here in detail. The techniques employed are known, in principle. The power transmission is performed, for example, via a 0-1 sequence on the bus, which is sent by the main battery or a bus master. For signal transmission, the signals from the bus participants are modified (attenuated) depending on the bus telegram. Via the inductive interfaces, the bus participants are connected with a respective bus driver, which carries out the modulation of the signal sequence (during transmission) and the reception (with demodulation) of the signals transmitted via the bus.

A plurality of primary coils may be arranged at the bus master in parallel or in series or in a mixed pattern. Series connection of two or more inductive interfaces is also possible.

In addition, electronic assembly units may be contained, which require inductive interfaces and the textile-supported supply line for their power supply only, but, by contrast, they communicate with the control unit and exchange data, for example, via RF interfaces.

If additional interfaces are present, the system according to the present invention can be combined without problems with additional electronic assembly units that have a decentralized power supply unit of their own. These additional interfaces may be designed, for example, as capacitive, conductive or radio-based interfaces. Thus, it is possible to integrate assembly units that do not have an inductive interface but are to be rapidly adapted for certain applications. Flexible systems with high compatibility can thus be assembled.

Hybrid systems with inductive interfaces, which have decentralized power supply units that comprise rechargeable power sources, for example, batteries, are also advantageous. The decentralized power supply units can be charged during phases during which the central supply module and an additional electronic assembly unit with a decentralized power supply unit are coupled with the textile-supported supply line via inductive interfaces. The operation of the electronic assembly units equipped with decentralized power supply units is thus ensured for a certain time even if the central supply module is not available. This may be advantageous, for example, when replacement of the central supply module becomes necessary in critical situations.

The portable supply module may advantageously be part of the equipment parts of a respirator, which are to be carried on the back. The primary coil of the inductive interface on the portable supply module may be equipped with an open ferrite core in this case.

An especially comfortable use of a modular system according to the present invention is obtained if at least one electronic assembly unit is present, during the coupling of which system functions are automatically activated. This may be, for example, an electronic assembly unit with a so-called ID tag (RFID, trasnponder, etc.).

Furthermore, it is advantageous if an electronic assembly unit activating the system functions is part of the central supply unit. It is thus possible to automatically activate the entire system with the putting on of the central supply unit, i.e., for example, the attachment of a support shell with a corresponding equipment without special activities being necessary for this on the part of the user.

The textile-supported supply line is advantageously integrated in pieces of clothing, which may be part of the protective clothing of mission personnel. Any form of flexible electric conductors that are suitable for the power supply of individual electronic assembly units and/or for data transmission and can be connected with textile structures or comprise textile structures themselves is defined as a textile-supported supply line in the sense of the present invention.

Especially flat coils for transmitting power and/or signals, which can be integrated in items of clothing, may be considered for use as inductive interfaces. By selecting advantageous positions for the inductive interfaces, it can be achieved that correct placement of the flat coils is automatically achieved simply by putting on or placing on the equipment, which rules out many configuration errors from the very beginning. The inductive interfaces may be integrated, for example, in undershirts, so-called “lifeshirts,” which are equipped with sensors or electrodes, in parts of the outer clothing, in protective suits or respirators. It is frequently ensured already by the shaping of the corresponding pieces of equipment that the transmission coils will always come to lie at the same site and consequently one on top of another. If textile-supported supply lines are integrated in a plurality of components to be worn on the body, it is advantageous if at least one inductive interface is arranged at a location at which at least two of these components to be worn on the body overlap. In the case of protective clothing, this can be achieved, for example, in the area of the collar and the neck apron of a protective helmet, in the overlapping area between pants and the jacket or in the back area. Locations at which a plurality of clothing layers may lie one on top of another without any appreciable shift in position occurring between the clothing layers are suitable for this, in principle.

In case of parts of equipment that are less strictly bound to a particular shape or position, it may be additionally advantageous if means for fixing the position of inductive interfaces are present. These means may comprise, for example, Velcro fasteners or other mechanical fastening means, for example, pockets, pushbuttons, permanent magnets, buttons, etc. Loose electronic parts of equipment may likewise be connected to the system on fastening surfaces prepared for this purpose with coils located under them.

If an inductive interface cannot be embodied in such a way that the items of clothing lie fittingly one over the other, it is possible to place a flat coil at the end of a conductor-reinforced, narrow textile web and to place this with a Velcro fastener in a suitable place on an opposite coil. A robust connection is thus established.

Furthermore, it is advantageous if at least one inductive interface is present, which can be reversibly connected with the textile-supported supply line. The modular system according to the present invention can thus be adapted to changing requirements very rapidly, i.e., additional positions can be found for the placement of a plurality of electronic assembly units, which are to communicate with the central control unit or are to be supplied with power from the supply module. The suitable electronic assembly units that must communicate with the central control unit include especially pressure sensors, motion sensors, temperature sensors, means for monitoring vital functions, means for monitoring pieces of equipment, cameras, thermal imaging systems, means for sending data to a base station or various gas sensors, but this list shall not be considered to be exhaustive.

The system according to the present invention may advantageously be used not only for mission personnel, but also for textile bus system solutions in spaceflight, for professional applications, for example, for safety engineers or maintenance technicians, divers, in sports for functional clothing, in the area of the entertainment industry or in medical engineering in the area of home care.

Furthermore, it may be advantageous to arrange the control unit with a radio set in the helmet. Thus, for example, the bus system can be put into operation when the helmet is put on. Only a small battery for the starting operation of the bus master is arranged in the helmet in this case because of the weight. The main power is advantageously obtained from a main battery on the belt or on a backpack.

The present invention will be explained in greater detail on the basis of an exemplary embodiment. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiment of the invention is illustrated.

### BRIEF DESCRIPTION OF THE DRAWINGS

In the drawings:

FIG. 1 is a schematic view of a minimum configuration according to the present invention;

FIG. 2 is a schematic view of a system according to the present invention as part of the protective equipment of firefighting mission personnel; and

FIG. 3 is a view of a firefighter equipped according to the present invention.

### DESCRIPTION OF THE PREFERRED EMBODIMENT

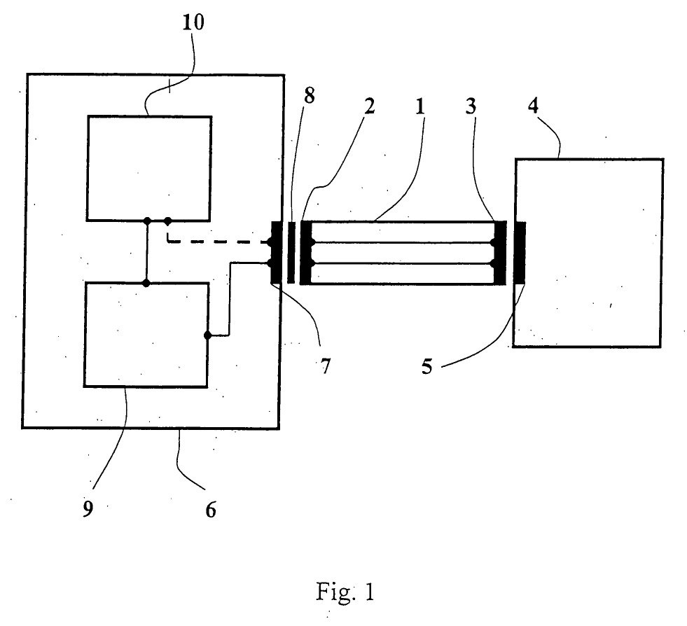

Referring to the drawings in particular, FIG. 1 shows a schematic view of a minimum configuration according to the present invention. A textile-supported supply line 1 ends on both sides at inductive interfaces, which contain flat coils 2, 3. An electronic assembly unit 4 likewise has an inductive interface with a flat coil 5 and can thus be coupled with the textile-supported supply line 1. The other end of the textile-supported supply line 1 leads to a central supply module 6, which is likewise coupled to the textile-supported supply line 1 via an inductive interface with a flat coil 7 and with an open ferrite core 8. The central supply module 6 contains a power supply unit 9 with a battery and a control unit 10.

The electronic assembly unit 4 may contain, for example, sensors for monitoring vital functions. The power necessary for the operation of the sensors is made available by the power supply unit 9 via the textile-supported supply line 1. In addition, a data exchange between the control unit 10 and the electronic assembly unit 4 containing the sensors can take place via the textile-supported supply line 1. The control unit 10 assumes a master function now. It actuates the sensors and coordinates the data polling. The control unit 10 is supplied with power via a direct connection between the control unit 10 and the power supply unit 9.

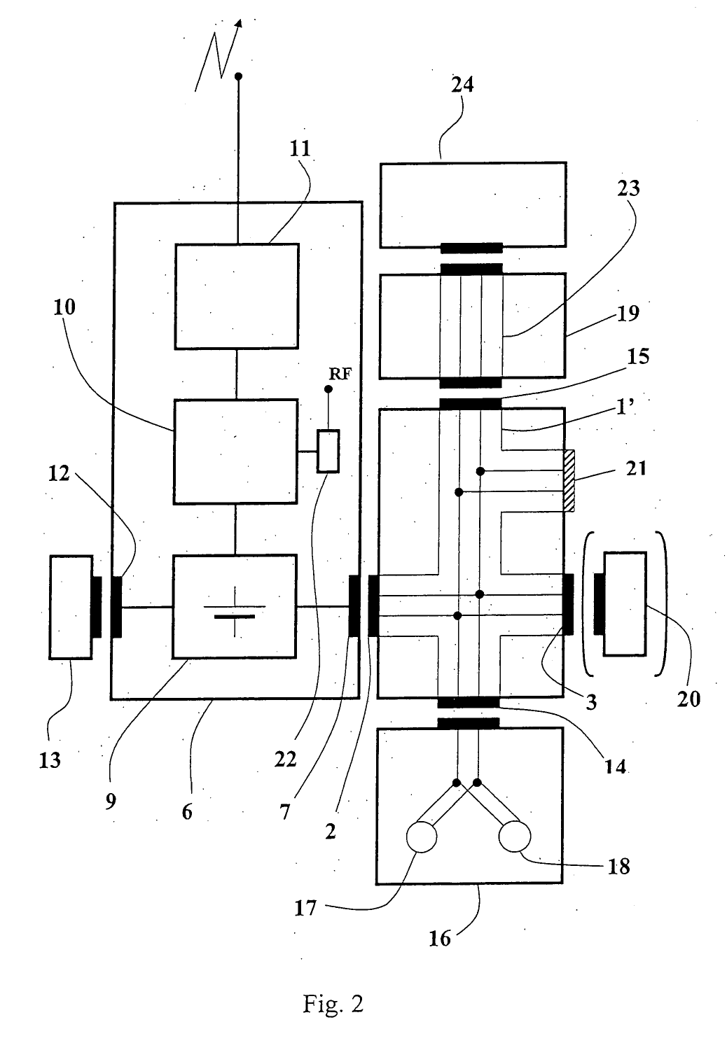

FIG. 2 shows a schematic view of a system according to the present invention as part of the protective equipment of firefighting mission personnel. A central supply module 6 integrated in the backpack of a respirator contains, in turn, a power supply unit 9 with a battery, a control unit 10 and additionally a radio unit 11, which is used, for example, for the communication between the user of the protective equipment with other mission personnel. The power supply unit 9, the control unit 10 and the radio unit 11 are connected with one another electrically. The central supply module 6 has inductive interfaces with flat coils 7, 12, which are connected with the power supply unit 9 and with the control unit 10. Additional components, for example, an ID tag 13, can be coupled with these inductive interfaces by means of inductive interfaces. The jacket of a protective suit is equipped in this example with a system of textile-supported supply lines 1′, which likewise end at inductive interfaces with flat coils 2, 3, 14, 15. The jacket is coupled via these interfaces with the central supply module. Additional electronic assembly units worn close to the body can be coupled with the other inductive interfaces on the jacket. In this case, it is a lifeshirt 16 with integrated sensors 17, 18 for measuring the heart rate and the body temperature, a safety mask 19 with integrated display as well as optionally an ID tag 20. The surface of the jacket has an area 21 prepared for receiving another inductive interface. Another flat coil can be connected in this area with the system of textile-supported supply lines 1′ by means of a Velcro system. It would thus be possible to supply another electronic assembly unit having an inductive interface with power via the system of textile-supported supply lines 1′. Due to the fact that exchange of data between the control unit 10 and the other electronic assembly units also takes place via the inductive interfaces, besides the power supply, the system according to the present invention also represents at the same time a bus system that can be expanded in a versatile manner, via which the communication of the individual electronic assembly units with the control unit 10 can take place, the control unit 10 having the function of a master. The control unit 10 additionally has a radio interface 22. Communication with electronic components that cannot participate in the data exchange with the control unit 10 via inductive interfaces is possible via this radio interface 22. The connected safety mask has a line 23, which is suitable for extending the bus system and leads to inductive interfaces. It is thus possible to couple additional electronic assembly units, for example, sensors or antennas integrated in a helmet 24, with the safety mask 19 and to include them in the power supply and communication concept.

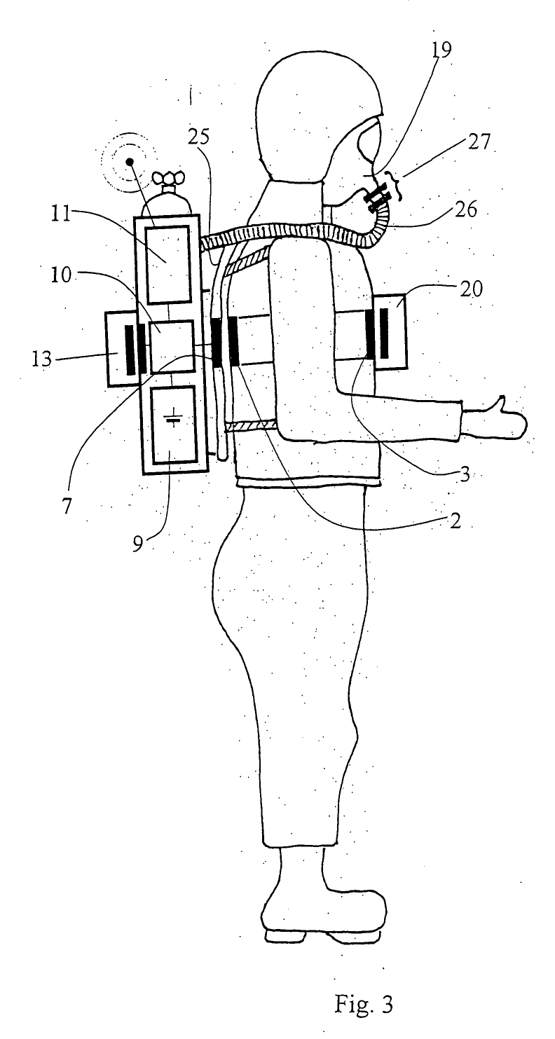

FIG. 3 shows a view of a firefighter equipped according to the present invention. The central supply module with the power supply unit 9, the control unit 10 and the radio unit 11 is permanently connected with the support shell 25 of a respirator. A system of textile-supported supply lines 1′, which leads to inductive interfaces with flat coils 2, 3, is integrated in the jacket of the protective suit. The central supply module is connected with the textile-supported supply line via an inductive interface 7 in the back area. A lifeshirt is likewise coupled with the inductive interface 7 in the back area via a flat coil (not visible). The connection of the individual components via inductive interfaces is used for the power supply by the power supply unit 9 and the data exchange with the control unit 10. ID tags 13, 20 may be integrated with the protective clothing or directly with the central supply module, for example, via inductive interfaces in the breast area. Capacitive interfaces may also be used for connecting ID tags. A breathing tube 26 leads to the breathing mask 19. The breathing tube 26 is likewise used as a supply line in this example and it likewise has at its mask-side end an inductive interface 27 for the connection of electronic components in the breathing mask 19.

Other possibilities for connecting electronic components in the breathing mask 19 are according to the present invention the use of inductive interfaces in the overlapping area of the protective clothing and the breathing mask or the use of large induction coils, for example, in the shoulder or helmet area, which make possible coupling over a greater distance.

The entire system can be configured in this exemplary embodiment such that the individual electronic assembly units can be supplied with power and switched on and participate in the communication simply by putting on the equipment. The system of textile-supported supply lines is thus also part of the bus system at the same time.

An advantage of such a bus system is that the electronic components can be optionally placed at different locations, depending on where the component causes less disturbance. For example, a gas-measuring device can thus be better arranged on the back than on the chest in case of crawling.

Due to the design as a single or double ring bus in case of especially demanding applications, higher reliability of operation can be achieved if there is a risk of wire break.

The power consumption of the central power supply unit can advantageously be reduced markedly by the sleep mode in case of non-use. It may be sufficient if short-term checking operating cycles are switched to the bus at longer intervals of time in order to check whether all the modules important for the mission are put on. If the important participants of the bus are present completely, the power supply goes into continuous operation. It may likewise be advantageous to specify the presence of a single important component as the criterion of switching on for the continuous operation. Such an important component may be an ID tag of the user of the equipment in the simplest case. This personal ID tag of a person participating in the mission is provided with an inductive interface and can be either coupled on any desired surface or on a surface provided for that purpose, or it is already built somewhere into the clothing or the helmet if these objects are personally assigned to the person participating in the mission. The identification of the user of the system according to the present invention can be brought about automatically with the establishment of the bus communication.

While a specific embodiment of the invention has been shown and described in detail to illustrate the application of the principles of the invention, it will be understood that the invention may be embodied otherwise without departing from such principles.

What is claimed is:

1. A modular system of units worn close to the body, the system comprising:
a textile-supported supply line leading to an inductive interface and another inductive interface;
an electronic assembly unit connected to said another inductive interface via an assembly unit inductive interface;
a portable supply module with a power supply unit and a control unit, said control unit assuming a master function in respect to said electronic assembly unit, said portable supply module having a portable supply inductive interface coupled with said textile-supported supply line via said inductive interface such that said electronic assembly unit is powered by said power supply unit contained in said portable supply module.

2. A modular system in accordance with claim 1, wherein said portable supply module comprises a radio unit for connection with additional mobile or stationary units.

3. A modular system in accordance with claim 1, wherein said portable supply module comprises a telemetry unit.

4. A modular system in accordance with claim 1, further comprising:
an additional electronic assembly unit with an inductive interface, wherein said portable supply module and said additional electronic assembly unit are coupled with said portable supply module inductive interface connected to said textile-supported supply line and said additional electronic assembly unit inductive interface connected to said textile-supported supply line such that data transmission is provided between the control unit and said additional electronic assembly unit.

5. A modular system in accordance with claim 6, wherein the portable supply module and said electronic assembly unit each have an RF interface, which makes possible data transmission between said control unit and said additional electronic assembly unit.

6. A modular system in accordance with claim 1, wherein said electronic assembly unit has a decentralized power supply unit.

7. A modular system inductive interface claim 6, wherein the decentralized power supply unit comprises a battery, which can be charged during phases during which said central supply module and said electronic assembly unit are coupled with the textile-supported supply line via inductive interfaces.

8. A modular system in accordance with claim 1, wherein said portable supply module is part of a respirator with a back carrying feature for carrying the respirator on the back.

9. A modular system in accordance with claim 1, further comprising a helmet, wherein said control unit is accommodated in said helmet.

10. A modular system in accordance with claim 1, wherein said electronic assembly unit includes system function activation means whereby upon coupling, system functions are activated.

11. A modular system in accordance with claim 10, wherein said system function activation means comprises an ID tag.

12. A modular system in accordance with claim 10, wherein said system function activation means is part of the central supply unit.

13. A modular system in accordance with claim 1, further comprising protective clothing wherein said textile-supported supply line is integrated in said protective clothing.

14. A modular system in accordance with claim 1, wherein said textile-supported supply line forms a ring bus.

15. A modular system in accordance with claim 1, wherein said inductive interfaces comprise flat coils.

16. A modular system in accordance with claim 1, wherein at least one said inductive interface can be reversibly connected with said textile-supported supply line.

17. A modular system in accordance with claim 1, wherein said textile-supported supply line is integrated in a plurality of components to be worn on the body, and at least one said inductive interface is arranged at a location at which there is an overlap of at least two components to be worn on the body.

18. A modular system in accordance with claim 1, further comprising a fixing means for fixing the position of inductive interfaces.

19. A modular system in accordance with claim 1, wherein said electronic assembly unit comprises at least one of a pressure sensor, a motion sensor, a temperature sensor, means for monitoring vital functions, means for monitoring pieces of equipment, a camera, a thermal imaging system, means for sending data to a base station and a gas sensor.

20. A modular system in accordance with claim 1, wherein at least one coil of an inductive interface is provided with an open ferrite core.
